(19) United States
(12) Patent Application Publication
(10) Pub. No.: US 2020/0385286 A1
(43) Pub. Date: Dec. 10, 2020

(54) DYNAMIC MULTI-OBJECTIVE PARTICLE SWARM OPTIMIZATION-BASED OPTIMAL CONTROL METHOD FOR WASTEWATER TREATMENT PROCESS

(71) Applicant: BEIJING UNIVERSITY OF TECHNOLOGY, BEIJING (CN)

(72) Inventors: HONGGUI HAN, BEIJING (CN); LU ZHANG, BEIJING (CN); JUNFEI QIAO, BEIJING (CN)

(21) Appl. No.: 16/696,967

(22) Filed: Nov. 26, 2019

(30) Foreign Application Priority Data
Jun. 10, 2019 (CN) 201910495404.5

(51) Int. Cl. C02F 1/00; G06Q 50/06; G06F 17/16

(52) U.S. Cl. CPC C02F 1/008; G06Q 50/06; G06F 17/16; C02F 2209/40; C02F 2209/22; C02F 2209/10; C02F 2209/16

(57) ABSTRACT

A dynamic multi-objective particle swarm optimization based optimal control method is provided to realize the control of dissolved oxygen (S_{O}) and the nitrate nitrogen (S_{NO}) in wastewater treatment process. In this method, dynamic multi-objective particle swarm optimization was used to optimize the operation objectives of WWTP, and the optimal solutions of S_{O} and S_{NO} can be calculated. Then PID controller was introduced to trace the dynamic optimal solutions of S_{O} and S_{NO}. The results demonstrated that the proposed optimal control strategy can address the dynamic optimal control problem, and guarantee the efficient and stable operation. In addition, this proposed optimal control method in this present invention can guarantee the effluent qualities and reduce the energy consumption.

### CROSS REFERENCE TO RELATED PATENT APPLICATIONS

This application claims priority to Chinese Patent Application No. 201910495404.5, filed on Jun. 10, 2019, entitled “Dynamic multi-objective particle swarm optimization-based optimal control method for wastewater treatment process,” which is hereby incorporated by reference in its entirety.

### TECHNICAL FIELD

In this present invention, a dynamic multi-objective particle swarm optimization (DMPSO) algorithm is used to solve the optimization objectives in wastewater treatment process (WWTP), and then the optimal solutions of dissolved oxygen (S_{O}) and nitrate nitrogen (S_{NO}) can be obtained. Both S_{O} and S_{NO} have an important influence on the energy consumption and effluent quality of WWTP, and determine the treatment effect of WWTP. It is necessary to design DMOPSO-based optimal control method to control S_{O} and S_{NO} for WWTP, which can guarantee the effluent qualities and reduce the energy consumption.

### BACKGROUND

WWTP refers to the physical, chemical and biological purification process of wastewater, so as to meet the requirements of discharge or reuse. Currently, natural freshwater resources have been fully exploited and natural disasters are increasingly occurred. Water shortage has posed a very serious threat to the economy and citizens' lives of many cities around the world. Water shortage crisis has been the reality we are facing. An important way to solve this problem is to turn the municipal wastewater into water supply source. Municipal wastewater is available in the vicinity, with the features of stable sources and easy collection. Stable and efficient wastewater treatment system is the key to the recycling of water resources, which has good environmental and social benefits. Therefore, the research results of the present invention have broad application prospects.

WWTP is a complex dynamic system. Its biochemical reaction cycle is long and pollutant composition is complex. Influent flow rate and influent qualities are passively accepted. And the primary performance indices pumping energy (PE), aeration energy (AE) and effluent quality (EQ) are strongly nonlinear and coupling. The essence of WWTP is dynamic multi-objective optimization control problem. It is significant to establish appropriate optimization objectives based to the dynamic operation characteristics of WWTP. Since the optimization objectives of WWTP are interactional, how to balance the relationship of the optimization objectives is of great significance to ensure the quality of effluent organisms and reduce energy consumption. In addition, S_{O} and S_{NO}, as the main control variables, have great influence on the operation efficiency and the operation performance. Therefore, it is necessary to establish a dynamic optimal control method, which can establish the optimization objectives and realize the tracking control according to the different operation conditions and the dynamic operation environments. The dynamic optimal control method can efficiently guarantee the effluent organisms in the limits and reduce the operation cost as much as possible.

In this present invention, a DMOPSO-based optimal control method is designed for WWTP, where the models of the performance indices can be established based on the dynamics and the operation data of WWTP. DMOPSO algorithm is designed to optimize the established optimization objectives and derive the optimal solutions of S_{O} and S_{NO}. Then multivariable PID controller is introduced to trace the optimal solutions S_{O} and S_{NO}.

### SUMMARY

In this present invention, a dynamic multi-objective particle swarm optimization-based optimal control method is designed for wastewater treatment process (WWTP), the steps are:

(1) design the models of performance indices for wastewater treatment process:

\textcircled{1} analysis the dynamic characteristics and the operation data of WWTP, obtain the related process variables of the key performance indices pumping energy (PE), aeration energy (AE) and effluent quality (EQ): influent flow rate (Qᵢₙ), dissolved oxygen (S_{O}), nitrate nitrogen (S_{NO}), ammonia nitrogen (S_{NH}), suspended solids (SS);

\textcircled{2} establish the models of the performance indices based on the operation time of S_{O} and S_{NO}, the operation time of S_{O} is thirty minutes, and the operation time of S_{NO} is two hours, the established models of the performance indices are adjusted per thirty minutes; if the operation time meets the operation time of S_{NO}, then the models are designed as:

$$\{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ x ( t ) - {c}_{2 r} ( t ) ‖}^{2} / 2 {{b}_{2 r} ( t )}^{2}} + {W}_{2} ( t )\end{matrix} \qquad ( 1 )$$

where f₁(t) is PE model at the tth time, f₂(t) is EQ model at the tth time, e^{-∥x(t)-c}^{₁ᵣ}^{(t)∥}^{²}^{/2b}^{₁ᵣ}^{(t)}^{²} and e^{-∥1(t)-c}^{₂ᵣ}^{(t)∥}^{²}^{/2b}^{₂ᵣ}^{(t)}^{²} are the rth radial basis function of f₁(t) and f₂(t) at the tth time, r=1, 2, . . . , 10, x(t)=[Qᵢₙ(t), S_{O}(t), S_{NO}(t), S_{NH}(t), SS(t)] is the input vector of PE model and EQ model, c₁ᵣ(t) and c₂ᵣ(t) are the centers of the rth radial basis function of f₁(t) and f₂(t) at the tth time, and the ranges of c₁ᵣ(t) and c₂ᵣ(t) are [−1, 1] respectively; b₁ᵣ(t) and b₂ᵣ(t) are the widths of the rth radial basis function of f₁(t) and f₂(t) at the tth time, and the ranges of b₁ᵣ(t) and b₂ᵣ(t) are [0, 2] respectively, W₁ᵣ(t) and W₂ᵣ(t) are the weights of the rth radial basis function of f₁(t) and f₂(t) at the tth time, and the ranges of W₁ᵣ(t) and W₂ᵣ(t) are [−3, 3] respectively; W₁(t) and W₂(t) are the output offsets of the rth radial basis function of f₁(t) and f₂(t) at the tth time, and the ranges of W₁(t) and W₂(t) are [−2, 2] respectively; if the operation time meets the time of S_{O}, then the models are designed as:

$$\{ \begin{matrix}{f}_{1} ( t ) = {\sum }_{r = 1}^{10} {W}_{1 r} \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} \times {e}^{- {‖ x ( t ) - {c}_{2 r} ( t ) ‖}^{2} / 2 {{b}_{2 r} ( t )}^{2}} + {W}_{2} ( t ) \\ {f}_{3} ( t ) = {\sum }_{r = 1}^{10} {W}_{3 r} \times {e}^{- {‖ x ( t ) - {c}_{3 r} ( t ) ‖}^{2} / 2 {{b}_{3 r} ( t )}^{2}} + {W}_{3} ( t )\end{matrix} \qquad ( 2 )$$

where f₃(t) is AE model at the tth time, e^{-∥s(t)-c}^{₃ᵣ}^{(t)∥}^{²}^{/2b}^{₃ᵣ}^{(t)}^{²} is the rth radial basis function of f₃(t) at the tth time, c₃ᵣ(t) is the center of the rth radial basis function of f₃(t) at the tth time, and the range of c₃ᵣ(t) is [−1, 1]; b₃ᵣ(t) is the widths of the rth radial basis function of f₃(t) at the tth time, and the range of b₃ᵣ(t) is [0, 2]; W₃ᵣ(t) is the weights of the rth radial basis function of f₃(t) at the tth time, and the range of W₃ᵣ(t) is [−3, 3]; W₃(t) is the output offset of the rth radial basis function of f₃(t), and the range of W₃(t) is [−2, 2];

(2) dynamic optimization of the control variables for WWTP

(2)-1 set the maximum iterative numbers of the optimization process Tₘₐₓ;

(2)-2 take the established models of performance indices as optimization objectives;

(2)-3 regard the inputs of the optimization objectives x(t)=[Qᵢₙ(t), S_{O}(t), S_{NO}(t), S_{NH}(t), SS(t)] as the position of the particles, calculate values of the optimization objectives, update the personal optimal position (pBest_{k,i}(t)) and the position and the velocity of the particles, the update process are:

x_{k,i}(t+1)=x_{k,i}(t)+v_{k,i}(t+1) (3)

v_{k,i}(t+1)=ω(t)v_{k,i}(t)+c₁α₁(pBest_{k,i}(t)−x_{k,i}(t))+c₂α₂(gBestₖ(t)−x_{k,i}(t)) (4)

where x_{k,i}(t+1) is the position of the ith particle in the kth iteration at the t+1th time, v_{k,i}(t+1) is the velocity of the ith particle in the kth iteration at the t+1th time, ω is the inertia weight, the range of ω is [0, 1], c₁ and c₂ are the learning parameters, α₁ and α₂ are the uniformly distributed random numbers, pBest_{k,i}(t) is the personal optimal position of the ith particle in the kth iteration at the tth time, and gBestₖ(t) is the personal optimal position in the kth iteration at the tth time;

(2)-4 design the diversity index and the convergence index based on the Chebyshev distance, diversity index is designed to measure the distribution quality of the non-dominated solutions,

$$U ( t ) = \sqrt{\frac{1}{NS ( t ) - 1} {\sum }_{m = 1}^{NS ( t )} {( \breve{D} ( t ) - {D}_{m} ( t ) )}^{2}} \qquad ( 5 )$$

where U(t) is the diversity of the optimal solutions at the tth time, m=1, 2, . . . , NS(t), NS(t) is the number of non-dominated solutions at time t, Ď(t) is the average distance of all the Chebyshev distance Dₘ(t), Dₘ(t) is the Chebyshev distance of consecutive solutions of the mth solution; and convergence index is developed to obtain the degree of proximity, which are calculated as

$$A ( t ) = \frac{1}{NS ( t )} \sqrt{{\sum }_{l = 1}^{NS ( t )} {d}_{l} ( t )} \qquad ( 6 )$$

where A(t) is the convergence of the optimal solutions at the tth time, dₗ(t) is the Chebyshev distance of the lth solution between the kth iteration and the k−1th iteration;

(2)-5 judge the changes of the optimization objectives, if the number of the objectives is changed, return to step (2)-6; otherwise, return to (2)-7;

(2)-6 when the number of the objectives is increased, some particles will be changed to enhance the diversity performance, the update process of the population size is

$${N}_{k + 1} ( t ) = \{ \begin{matrix}{N}_{k} ( t ) & {α}_{k} ( t ) = 0 \\ {N}_{k} ( t ) - ( {N}_{k} ( t ) - {NS}_{k} ( t ) ) \cdot {α}_{k} ( t ) & {α}_{k} ( t ) < 0 \\ {N}_{k} ( t ) + {NS}_{k} ( t ) \cdot {α}_{k} ( t ) & {α}_{k} ( t ) > 0\end{matrix} \qquad ( 7 )$$

where Nₖ₊₁(t) and Nₖ(t) are the population size in the kth iteration and in the k+1th iteration at the tth time respectively, αₖ(t) is the gradient of diversity in the kth iteration at the tth time, which is calculated as

$${α}_{k} ( t ) = \frac{{U}_{k} ( t ) - {U}_{k} ( t - ɛ )}{ɛ} \qquad ( 8 )$$

where ε is the adjusted frequency of population size, and the range of ε is [1, Tₘₐₓ]; if the number of the objectives is decreased, some particles will be changed to improve the convergence performance, the update process of the population size is

$${N}_{k + 1} ( t ) = \{ \begin{matrix}{N}_{k} ( t ) & {β}_{k} ( t ) = 0 \\ {N}_{k} ( t ) + {NS}_{k} ( t ) \cdot {β}_{k} ( t ) & {β}_{k} ( t ) < 0 \\ {N}_{k} ( t ) - ( {N}_{k} ( t ) - {NS}_{k} ( t ) ) \cdot {β}_{k} ( t ) & {β}_{k} ( t ) > 0\end{matrix} \qquad ( 9 )$$

where βₖ(t) is the gradient of convergence in the kth iteration at the tth time, which is calculated as

$${β}_{k} ( t ) = \frac{{A}_{k} ( t ) - {A}_{k} ( t - ɛ )}{ɛ} \qquad ( 10 )$$

(2)-7 compare pBestₖ(t) with the solutions Φₖ₋₁(t) in the archive, where Φₖ₋₁(t)=[yφ_{k-1,1}(t), φ_{k-1,2}(t), . . . , φ_{k-1,ι}(t)], φ_{k-1,ι}(t) is the ιth optimal solutions in the k−1th iteration at the tth time of the archive, the archive Φₖ(t) is updated by the dominated relationship, and the calculation process of the dominated relationship can be shown as

Φₖ(t)=Φₖ₋₁(t)∪pₖ₋₁(t), if fₕ(a_{k-ι}(t))≥fₕ(pₖ(t)), h=1, 2, 3 (11)

where ∪ is the relationship of combine, if the value of pBestₖ₋₁(t) is lower than the objective value of a_{k-1,ι}(t), then the pBestₖ₋₁(t) will be saved in the archive, otherwise, a_{k-1,ι}(t) will be saved, then gBestₖ(t) will be selected from the archive according to the density method;

(2)-8 if the current iteration is greater than the preset Tₘₐₓ, then return to step (2)-9, otherwise, return to step (2)-3;

(2)-9 select a set of global optimal solutions gBest_{Tmax}(t) from the archive randomly, and gBest_{Tmax}(t)=[Q_{in,Tmax}*(t), S_{O,Tmax}*(t), S_{NO,Tmax}*(t), S_{NH,Tmax}*(t), SS_{Tmax}*(t)], where Q_{in,Tmax}*(t) is the optimal solution of influent flow rate, S_{O,Tmax}*(t) is the optimal solution of dissolved oxygen, S_{NO,Tmax}*(t) is the optimal solution of nitrate nitrogen, S_{NH,Tmax}*(0 is the optimal solution of ammonia nitrogen, SS_{Tmax}*(t) is the optimal solution of suspend solid;

(3) tracking control of the optimal solutions in WWTP

(3)-1 design the multivariable PID controller, the output of PID controller is shown as

$$Δ u ( t ) = {K}_{p} [ e ( t ) + {H}_{τ} {\int }_{0}^{t} e ( t ) dt + {H}_{d} \frac{de ( t )}{dt} ] \qquad ( 12 )$$

where Δu(t)=[ΔK_{L}a₅(t), ΔQₐ(t)]^{T}, ΔK_{L}a₅(t) is the error of the oxygen transfer coefficient in the fifth unit at time t, ΔQₐ(t) is the error of the internal recycle flow rate at time t, Kₚ is the proportionality coefficient; H_{τ} is the integral time constants; H_{d} is the differential time constants; e(t) is the error between the real output and the optimal solution

e(t)=z(t)−y(t) (13)

where e(t)=[e₁(t), e₂(t)]^{T}, e₁(t) and e₂(t) are the errors of S_{O} and S_{NO}, respectively; z(t)=[z₁(t), z₂(t)]^{T}, z₁(t) is the optimal set-point concentration of S_{O} at time t, z₂(t) is the optimal set-point concentration of S_{NO} at time t, y(t)=[y₁(t), y₂(t)]^{T}, y₁(t) is the concentration of S_{O} at time t, y₂(t) is the concentration of S_{NO} at time t;

(3)-2 the outputs of PID controller are the variation of the manipulated variables oxygen transfer coefficient (ΔK_{L}a) and internal circulation return flow (ΔQₐ);

(4) take ΔK_{L}a and ΔQₐ as the input of the control system of WWTP, and then control S_{O} and S_{NO} by the calculated ΔK_{L}a and ΔQₐ, and the outputs of the control system in WWTP are the real concentration of S_{O} and S_{NO}.

### The Novelties of this Present Disclosure Contain

(1) In this present invention, the multiple time-scale optimization problem is designed based on the dynamic characteristics the operation data of WWTP. DMOPSO algorithm is designed to optimize the multi-time-scale optimization objectives and calculate the optimal solutions.

(2) DMOPSO-based optimal control method is proposed to realize the optimization of the operation performance. The dynamic optimal solutions of S_{O} and S_{NO} can be derived and traced by the proposed optimal control method.

Attention: for the convenient description, multi-time-scale optimization objectives, DMOPSO algorithm and multivariable PID controller are used to realize the optimal control of WWTP. The other optimal control methods based on different multi-time-scale optimization objectives, dynamic optimization algorithm and control strategy also belong to the scope of this present invention.

### BRIEF DESCRIPTION OF THE DRAWINGS

FIG. 1 shows the results of S_{O} in DMOPSP-based method.

FIG. 2 shows the results of S_{NO} in DMOPSP-based method.

### DETAILED DESCRIPTION

A dynamic multi-objective particle swarm optimization-based optimal control method is designed for wastewater treatment process (WWTP), the steps are:

(1) design the models of performance indices for wastewater treatment process:

\textcircled{1} analysis the dynamic characteristics and the operation data of WWTP, obtain the related process variables of the key performance indices pumping energy (PE), aeration energy (AE) and effluent quality (EQ): influent flow rate (Qᵢₙ), dissolved oxygen (S_{O}), nitrate nitrogen (S_{NO}), ammonia nitrogen (S_{NH}), suspended solids (SS);

\textcircled{2} establish the models of the performance indices based on the operation time of S_{O} and S_{NO}, the operation time of S_{O} is thirty minutes, and the operation time of S_{NO} is two hours, the established models of the performance indices are adjusted per thirty minutes; if the operation time meets the operation time of S_{NO}, then the models are designed as:

$$\{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ x ( t ) - {c}_{2 r} ( t ) ‖}^{2} / 2 {{b}_{2 r} ( t )}^{2}} + {W}_{2} ( t )\end{matrix} \qquad ( 1 )$$

where f₁(t) is PE model at the tth time, f₂(t) is EQ model at the tth time, e^{-∥x(t)-c}^{₁ᵣ}^{(t)∥}^{²}^{/2b}^{₁ᵣ}^{(t)}^{²} and e^{-∥1(t)-c}^{₂ᵣ}^{(t)∥}^{²}^{/2b}^{₂ᵣ}^{(t)}^{²} are the rth radial basis function of f₁(t) and f₂(t) at the tth time, r=1, 2, . . . , 10, x(t)=[Qᵢₙ(t), S_{O}(t), S_{NO}(t), S_{NH}(t), SS(t)] is the input vector of PE model and EQ model, c₁ᵣ(t) and c₂ᵣ(t) are the centers of the rth radial basis function of f₁(t) and f₂(t) at the tth time, and the ranges of c₁ᵣ(t) and c₂ᵣ(t) are [−1, 1] respectively; b₁ᵣ(t) and b₂ᵣ(t) are the widths of the rth radial basis function of f₁(t) and f₂(t) at the tth time, and b₁ᵣ(t)=1.2, b₂ᵣ(t)=1.2; W₁ᵣ(t) and W₂ᵣ(t) are the weights of the rth radial basis function of f₁(t) and f₂(t) at the tth time, and W₁ᵣ(t)=2.4, W₂ᵣ(t)=1.8; W₁(t) and W₂(t) are the output offsets of the rth radial basis function of f₁(t) and f₂(t) at the tth time, and W₁(t)=0.8, W₂(t)=−0.2; if the operation time meets the time of S_{O}, then the models are designed as:

$$\{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ x ( t ) - {c}_{2 r} ( t ) ‖}^{2} / 2 {{b}_{2 r} ( t )}^{2}} + {W}_{2} ( t ) \\ {f}_{3} ( t ) = {\sum }_{r = 1}^{10} {W}_{3 r} ( t ) \times {e}^{- {‖ x ( t ) - {c}_{3 r} ( t ) ‖}^{2} / 2 {{b}_{3 r} ( t )}^{2}} + {W}_{3} ( t )\end{matrix} \qquad ( 2 )$$

where f₃(t) is AE model at the tth time, e^{-∥s(t)-c}^{₃ᵣ}^{(t)∥}^{²}^{/2b}^{₃ᵣ}^{(t)}^{²} is the rth radial basis function of f₃(t) at the tth time, c₃ᵣ(t) is the center of the rth radial basis function of f₃(t) at the tth time, and the range of c₃ᵣ(t) is [−1, 1]; b₃ᵣ(t) is the widths of the rth radial basis function of f₃(t) at the tth time, and b₃ᵣ(t)=0.5, W₃ᵣ(t) is the weights of the rth radial basis function of f₃(t) at the tth time, and W₃ᵣ=1.4; W₃(t) is the output offset of the rth radial basis function of f₃(t), and W₂(t)=−1.2;

(2) dynamic optimization of the control variables for WWTP

(2)-1 set the maximum iterative numbers of the optimization process Tₘₐₓ, Tₘₐₓ=200;

(2)-2 take the established models of performance indices as optimization objectives;

(2)-3 regard the inputs of the optimization objectives x(t)=[Qᵢₙ(t), S_{O}(t), S_{NO}(t), S_{NH}(t), SS(t)] as the position of the particles, calculate values of the optimization objectives, update the personal optimal position (pBest_{k,i}(t)) and the position and the velocity of the particles, the update process are:

x_{k,i}(t+1)=x_{k,i}(t)+v_{k,i}(t+1) (3)

v_{k,i}(t+1)=ω(t)v_{k,i}(t)+c₁α₁(pBest_{k,i}(t)−x_{k,i}(t))+c₂α₂(gBestₖ(t)−x_{k,i}(t)) (4)

where x_{k,i}(t+1) is the position of the ith particle in the kth iteration at the t+1th time, v_{k,i}(t+1) is the velocity of the ith particle in the kth iteration at the t+1th time, ω is the inertia weight, ω=0.8, c₁ and c₂ are the learning parameters, c₁=0.4, c₂=0.4, α₁ and α₂ are the uniformly distributed random numbers, α₁=0.2, α₂=0.2, pBest_{k,i}(t) is the personal optimal position of the ith particle in the kth iteration at the tth time, and gBestₖ(t) is the personal optimal position in the kth iteration at the tth time;

(2)-4 design the diversity index and the convergence index based on the Chebyshev distance, diversity index is designed to measure the distribution quality of the non-dominated solutions,

$$U ( t ) = \sqrt{\frac{1}{NS ( t ) - 1} {\sum }_{m = 1}^{NS ( t )} {( \breve{D} ( t ) - {D}_{m} ( t ) )}^{2}} \qquad ( 5 )$$

where U(t) is the diversity of the optimal solutions at the tth time, m=1, 2, . . . , NS(t), NS(t) is the number of non-dominated solutions at time t, Ď(t) is the average distance of all the Chebyshev distance Dₘ(t), Dₘ(t) is the Chebyshev distance of consecutive solutions of the mth solution; and convergence index is developed to obtain the degree of proximity, which are calculated as

$$A ( t ) = \frac{1}{NS ( t )} \sqrt{{\sum }_{l = 1}^{NS ( t )} {d}_{l} ( t )} \qquad ( 6 )$$

where A(t) is the convergence of the optimal solutions at the tth time, dₗ(t) is the

Chebyshev distance of the lth solution between the kth iteration and the k−1th iteration;

(2)-5 judge the changes of the optimization objectives, if the number of the objectives is changed, return to step (2)-6; otherwise, return to (2)-7;

(2)-6 when the number of the objectives is increased, some particles will be changed to enhance the diversity performance, the update process of the population size is

$${N}_{k + 1} ( t ) = \{ \begin{matrix}{N}_{k} ( t ) & {α}_{k} ( t ) = 0 \\ {N}_{k} ( t ) - ( {N}_{k} ( t ) - {NS}_{k} ( t ) ) \cdot {α}_{k} ( t ) & {α}_{k} ( t ) < 0 \\ {N}_{k} ( t ) + {NS}_{k} ( t ) \cdot {α}_{k} ( t ) & {α}_{k} ( t ) > 0\end{matrix} \qquad ( 7 )$$

where Nₖ₊₁(t) and Nₖ(t) are the population size in the kth iteration and in the k+1th iteration at the tth time respectively, αₖ(t) is the gradient of diversity in the kth iteration at the tth time, which is calculated as

$${α}_{k} ( t ) = \frac{{U}_{k} ( t ) - {U}_{k} ( t - ɛ )}{ɛ} \qquad ( 8 )$$

where ε is the adjusted frequency of population size, and the range of ε is [1, 200]; if the number of the objectives is decreased, some particles will be changed to improve the convergence performance, the update process of the population size is

$${N}_{k + 1} ( t ) = \{ \begin{matrix}{N}_{k} ( t ) & {β}_{k} ( t ) = 0 \\ {N}_{k} ( t ) + {NS}_{k} ( t ) \cdot {β}_{k} ( t ) & {β}_{k} ( t ) < 0 \\ {N}_{k} ( t ) - ( {N}_{k} ( t ) - {NS}_{k} ( t ) ) \cdot {β}_{k} ( t ) & {β}_{k} ( t ) > 0\end{matrix} \qquad ( 9 )$$

where βₖ(t) is the gradient of convergence in the kth iteration at the tth time, which is calculated as

$${β}_{k} ( t ) = \frac{{A}_{k} ( t ) - {A}_{k} ( t - ɛ )}{ɛ} \qquad ( 10 )$$

(2)-7 compare pBestₖ(t) with the solutions Φₖ₋₁(t) in the archive, where Φₖ₋₁(t)=[φ_{k-1,1}(t), φ_{k-1,2}(t), . . . , φ_{k-1,ι}(t)], φ_{k-1,ι}(t) is the ιth optimal solutions in the k-−1th iteration at the tth time of the archive, the archive Φₖ(t) is updated by the dominated relationship, and the calculation process of the dominated relationship can be shown as

Φₖ(t)=Φₖ₋₁(t)∪pₖ₋₁(t), if fₕ(aₖ₋ᵢ(t))≥fₕ(pₖ(t)), h=1, 2, 3 (11)

where ∪ is the relationship of combine, if the value of pBestₖ₋₋₁(t) is lower than the objective value of a_{k-1,ι}(t), then the pBestₖ₋₁(t) will be saved in the archive, otherwise, a_{k-1,iι}(t) will be saved, then gBestₖ(t) will be selected from the archive according to the density method;

(2)-8 if the current iteration is greater than the preset Tₘₐₓ, then return to step (2)-9, otherwise, return to step (2)-3;

(2)-9 select a set of global optimal solutions gBest_{Tmax}(t) from the archive randomly, and gBest_{Tmax}(t)=[Q_{in,Tmax}*(t), S_{O,Tmax}*(t), S_{NO,Tmax}*(t), S_{NH,Tmax}*(t), SS_{Tmax}*(t)], where Q_{in,Tmax}* (t) is the optimal solution of influent flow rate, S_{O,Tmax}*(t) is the optimal solution of dissolved oxygen, S_{NO,Tmax}*(t) is the optimal solution of nitrate nitrogen, S_{NH,Tmax}*(t) is the optimal solution of ammonia nitrogen, SS_{Tmax}*(t) is the optimal solution of suspend solid;

(3) tracking control of the optimal solutions in WWTP

(3)-1 design the multivariable PID controller, the output of PID controller is shown as

$$Δ u ( t ) = {K}_{p} [ e ( t ) + {H}_{τ} {\int }_{0}^{t} e ( t ) dt + {H}_{d} \frac{de ( t )}{dt} ] \qquad ( 12 )$$

where Δu(t)=[ΔK_{L}a₅(t), ΔQₐ(t)]^{T}, ΔK_{L}a₅(t) is the error of the oxygen transfer coefficient in the fifth unit at time t, ΔQₐ(t) is the error of the internal recycle flow rate at time t, Kₚ is the proportionality coefficient; H_{τ} is the integral time constants; H_{d} is the differential time constants; e(t) is the error between the real output and the optimal solution

e(t)=z(t)−y(t) (13)

where e(t)=[e₁(t), e₂(t)]^{T}, e₁(t) and e₂(t) are the errors of S_{O} and S_{NO}, respectively; z(t)=[z₁(t), z₂(t)]^{T}, z₁(t) is the optimal set-point concentration of S_{O} at time t, z₂(t) is the optimal set-point concentration of S_{NO} at time t, y(t)=[y₁(t), y₂(t)]^{T}, y₁(t) is the concentration of S_{O} at time t, y₂(t) is the concentration of S_{NO} at time t;

(3)-2 the outputs of PID controller are the variation of the manipulated variables oxygen transfer coefficient (ΔK_{L}a) and internal circulation return flow (ΔQₐ);

(4) take ΔK_{L}a and ΔQₐ as the input of the control system of WWTP, and then control S_{O} and S_{NO} by the calculated ΔK_{L}a and ΔQₐ, and the outputs of the control system in WWTP are the real concentration of S_{O} and S_{NO}.

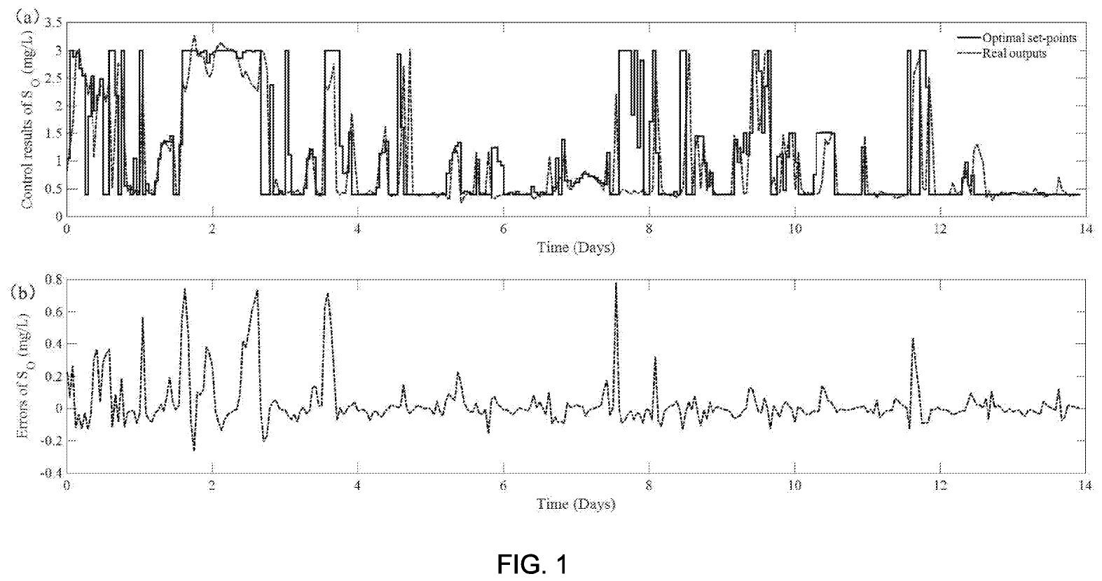

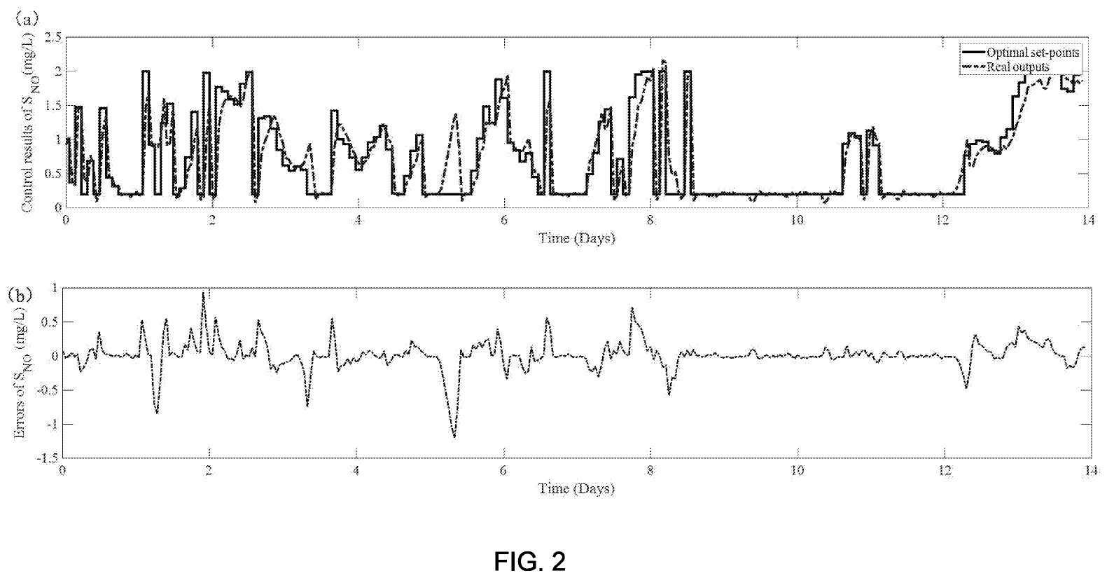

The outputs of the control system based on DMOPSO-based optimal control method is the concentration of S_{O} and S_{NO}. FIG. 1(a) gives S_{O} values, X axis shows the time, and the unit is day, Y axis is control results of S_{O}, and the unit is mg/L. FIG. 1(b) gives the control errors of S_{O}, X axis shows the time, and the unit is day, Y axis is control errors of S_{O}, and the unit is mg/L. FIG. 2(a) gives the S_{NO} values, X axis shows the time, and the unit is day, Y axis is control results of S_{NO}, and the unit is mg/L. FIG. 2(b) gives the control errors of S_{NO}, X axis shows the time, and the unit is day, Y axis is control errors of S_{NO}, and the unit is mg/L.

What is claimed is:

1. A dynamic multi-objective particle swarm optimization-based optimal control method for a wastewater treatment process (WWTP), comprising:
(1) design models of performance indices for the wastewater treatment process:
\textcircled{1} analysis dynamic characteristics and operation data of the WWTP, obtain process variables: influent flow rate (Qᵢₙ) dissolved oxygen (S_{O}), nitrate nitrogen (S_{NO}), ammonia nitrogen (S_{NH}), suspended solids (SS), which are related to the performance indices including pumping energy (PE), aeration energy (AE) and effluent quality (EQ);
\textcircled{2} establish models of the performance indices based on the operation time of S_{O} and S_{NO}, the operation time of S_{O} is thirty minutes, and the operation time of S_{NO} is two hours, the established models of the performance indices are adjusted per thirty minutes; if an operation time meets the operation time of S_{NO} only, then the models are designed as:
$$\{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ x ( t ) - {c}_{2 r} ( t ) ‖}^{2} / 2 {{b}_{2 r} ( t )}^{2}} + {W}_{2} ( t )\end{matrix} \qquad ( 1 )$$
where f₁(t) is PE model at tth time, f₂(t) is EQ model at tth time, e^{-∥x(t)-c}^{₁ᵣ}^{(t)∥}^{²}^{/2b}^{₁ᵣ}^{(t)}^{²} and e^{-∥1(t)-c}^{₂ᵣ}^{(t)∥}^{²}^{/2b}^{₂ᵣ}^{(t)}^{²} are rth radial basis function of f₁(t) and f₂(t) at the tth time, r=1, 2, . . . , 10, x(t)=[Qᵢₙ(t), S_{O}(t), S_{NO}(t), S_{NH}(t), SS(t)] is an input vector of PE model and EQ model, c₁ᵣ(t) and c₂ᵣ(t) are centers of the rth radial basis function of f₁(t) and f₂(t) at the tth time, and ranges of c₁ᵣ(t) and c₂ᵣ(t) are [−1, 1] respectively; b₁ᵣ(t) and b₂ᵣ(t) are widths of the rth radial basis function of f₁(t) and f₂(t) at the tth time, and ranges of b₁ᵣ(t) and b₂ᵣ(t) are [0, 2] respectively, W₁ᵣ(t) and W₂ᵣ(t) are weights of the rth radial basis function of f₁(t) and f₂(t) at the tth time, and ranges of W₁ᵣ(t) and W₂ᵣ(t) are [−3, 3] respectively; W₁(t) and W₂(t) are output offsets of the rth radial basis function of f₁(t) and f₂(t) at the tth time, and ranges of W₁(t) and W₂(t) are [−2, 2] respectively; if the operation time meets the time of S_{O}, then the models are designed as:
$$\{ \begin{matrix}{f}_{1} ( t ) = {\sum }_{r = 1}^{10} {W}_{1 r} ( t ) \times {e}^{- {‖ x ( t ) - {c}_{1 r} ( t ) ‖}^{2} / 2 {{b}_{1 r} ( t )}^{2}} + {W}_{1} ( t ) \\ {f}_{2} ( t ) = {\sum }_{r = 1}^{10} {W}_{2 r} ( t ) \times {e}^{- {‖ x ( t ) - {c}_{2 r} ( t ) ‖}^{2} / 2 {{b}_{2 r} ( t )}^{2}} + {W}_{2} ( t ) \\ { }_{{f}_{3}} ( t ) = {\sum }_{r = 1}^{10} {W}_{3 r} ( t ) \times {e}^{- {‖ x ( t ) - {c}_{3 r} ( t ) ‖}^{2} / 2 {{b}_{3 r} ( t )}^{2}} + {W}_{3} ( t )\end{matrix} \qquad ( 2 )$$
where f₃(t) is AE model at the tth time, e^{-∥s(t)-c}^{₃ᵣ}^{(t)∥}^{²}^{/2b}^{₃ᵣ}^{(t)}^{²} is rth radial basis function of f₃(t) at the tth time, c₃ᵣ(t) is center of the rth radial basis function of f₃(t) at the tth time, and a range of c₃ᵣ(t) is [−1, 1]; b₃ᵣ(t) is widths of the rth radial basis function of f₃(t) at the tth time, and a range of b₃ᵣ(t) is [0, 2]; W₃ᵣ(t) is weights of the rth radial basis function of f₃(t) at the tth time, and a range of W₃ᵣ(t) is [−3, 3]; W₃(t) is an output offset of the rth radial basis function of f₃(t), and a range of W₃(t) is [−2, 2];
(2) dynamic optimization of the control variables for WWTP
(2)-1 set maximum iterative numbers of optimization process Tₘₐₓ;
(2)-2 take the established models of the performance indices as optimization objectives;
(2)-3 regard inputs of the optimization objectives x(t)=[Qᵢₙ(t), S_{O}(t), S_{NO}(t), S_{NH}(t), SS(t)] as the position of particles, calculate values of the optimization objectives, update personal optimal position (pBest_{k,i}(t) and the position and velocity of the particles, the update process is:
x_{k,i}(t+1)=x_{k,i}(t)+v_{k,i}(t+1) (3)
v_{k,i}(t+1)=ω(t)v_{k,i}(t)+c₁α₁(pBest_{k,i}(t)−x_{k,i}(t))+c₂α₂(gBestₖ(t)−(t)) (4)
where x_{k,i}(t+1) is the position of ith particle in kth iteration at t+1th time, v_{k,i}(t+1) is the velocity of the ith particle in the kth iteration at the t+1th time, ω is inertia weight, a range of ω is [0, 1], cl₁ and c₂ are learning parameters, α₁ and α₂ are uniformly distributed random numbers, pBest_{k,i}(t) is personal optimal position of the ith particle in the kth iteration at the tth time, and gBestₖ(t) is personal optimal position in the kth iteration at the tth time;
(2)-4 design diversity index and convergence index based on the Chebyshev distance, the diversity index is designed to measure distribution quality of non-dominated solutions,
$$U ( t ) = \sqrt{\frac{1}{NS ( t ) - 1} {\sum }_{m = 1}^{NS ( t )} {( \breve{D} ( t ) - {D}_{m} ( t ) )}^{2}} \qquad ( 5 )$$
where U(t) is diversity of optimal solutions at the tth time, m=1, 2, . . . , NS(t), NS(t) is the number of non-dominated solutions at time t, Ď(t) is average distance of all the Chebyshev distance Dₘ(t), Dₘ(t) is Chebyshev distance of consecutive solutions of the mth solution; and the convergence index is developed to obtain degree of proximity, which is calculated as
$$A ( t ) = \frac{1}{NS ( t )} \sqrt{{\sum }_{l = 1}^{NS ( t )} {d}_{l} ( t )} \qquad ( 6 )$$
where A(t) is the convergence of the optimal solutions at the tth time, dₗ(t) is the Chebyshev distance of the lth solution between the kth iteration and the k−1th iteration;
(2)-5 judge changes of the optimization objectives, if the number of the objectives is changed, return to step (2)-6; otherwise, return to (2)-7;
(2)-6 when the number of the objectives is increased, some particles will be changed to enhance diversity performance, the update process of population size is
$${N}_{k + 1} ( t ) = \{ \begin{matrix}{N}_{k} ( t ) & {α}_{k} ( t ) = 0 \\ {N}_{k} ( t ) - ( {N}_{k} ( t ) - {NS}_{k} ( t ) ) \cdot {α}_{k} ( t ) & {α}_{k} ( t ) < 0 \\ {N}_{k} ( t ) + {NS}_{k} ( t ) \cdot {α}_{k} ( t ) & {α}_{k} ( t ) > 0\end{matrix} \qquad ( 7 )$$
where Nₖ₊₁(t) and Nₖ(t) are population size in kth iteration and in k+1th iteration at the tth time respectively, αₖ(t) is gradient of diversity in the kth iteration at the tth time, which is calculated as
$${α}_{k} ( t ) = \frac{{U}_{k} ( t ) - {U}_{k} ( t - ɛ )}{ɛ} \qquad ( 8 )$$
where ε is an adjusted frequency of the population size, and a range of ε is [1, Tₘₐₓ]; if the number of the objectives is decreased, some particles will be changed to improve the convergence performance, the update process of the population size is
$${N}_{k + 1} ( t ) = \{ \begin{matrix}{N}_{k} ( t ) & {β}_{k} ( t ) = 0 \\ {N}_{k} ( t ) + {NS}_{k} ( t ) \cdot {β}_{k} ( t ) & {β}_{k} ( t ) < 0 \\ {N}_{k} ( t ) - ( {N}_{k} ( t ) - {NS}_{k} ( t ) ) \cdot {β}_{k} ( t ) & {β}_{k} ( t ) > 0\end{matrix} \qquad ( 9 )$$
where βₖ(t) is gradient of convergence in the kth iteration at the tth time, which is calculated as
$${β}_{k} ( t ) = \frac{{A}_{k} ( t ) - {A}_{k} ( t - ɛ )}{ɛ} \qquad ( 10 )$$
(2)-7 compare pBestₖ(t) with solutions Φₖ₋₁(t) in the archive, where Φₖ₋₁(t)=[φ_{k-1,1}(t), φ_{k-1,2}(t) , . . . , φ_{k-1,ι}(t)], φ_{k-1,ι}(t) is ιth optimal solutions in k−1th iteration at the tth time of the archive, the archive Φₖ(t) is updated by a dominated relationship, and the calculation process of the dominated relationship is:
Φₖ(t)=Φₖ₋₁(t)∪pₖ₋₁(t), if fₕ(a_{k-ι}(t))≥fₕ(pₖ(t)), h=1,2,3 (11)
where ∪ is a relationship of combine, if a value of pBestₖ₋₁(t) is lower than an objective value of a_{k-1,ι}(t), then the pBestₖ₋₁(t) will be saved in the archive, otherwise, a_{k-1,ι}(t) will be saved, then gBestₖ(t) will be selected from the archive according to the density method;
(2)-8 if the current iteration is greater than the preset Tₘₐₓ, then return to step (2)-9, otherwise, return to step (2)-3;
(2)-9 select a set of global optimal solutions gBest_{Tmax}(t) from the archive randomly, and gBest_{Tmax}(t)=[Q_{in,Tmax}*(t), S_{O,Tmax}*(t), S_{NO,Tmax}*(t), S_{NH,Tmax}*(t), SS_{Tmax}*(t)], where Q_{in,Tmax}*(t) is an optimal solution of influent flow rate, S_{O,Tmax}*(t) is an optimal solution of dissolved oxygen, S_{NO,Tmax}*(t) is an optimal solution of nitrate nitrogen, S_{NH,Tmax}*(t) is an optimal solution of ammonia nitrogen, SS_{Tmax}*(t) is an optimal solution of suspend solid;
(3) tracking control of the optimal solutions in WWTP
(3)-1 design the multivariable PID controller, the output of PID controller is shown as
$$Δ u ( t ) = {K}_{p} [ e ( t ) + {H}_{τ} {\int }_{0}^{t} e ( t ) dt + {H}_{d} \frac{de ( t )}{dt} ] \qquad ( 12 )$$
where Δu(t)=[ΔK_{L}a₅(t), ΔQₐ(t)]^{T}, ΔK_{L}a₅(t) is error of oxygen transfer coefficient in fifth unit at time t, ΔQₐ(t) is error of internal recycle flow rate at time t, Kₚ is a proportionality coefficient; H_{τ} is a integral time constant; H_{d} is a differential time constant; e(t) is error between a real output and the optimal solution
e(t)=z(t)−y(t) (13)
where e(t)=[e₁(t), e₂(t)]^{T}, e₁(t) and e₂(t) are errors of S_{O} and S_{NO}, respectively; z(t)=[z₁(t), z₂(t)]^{T}, z₁(t) is an optimal set-point concentration of S_{O} at time t, z₂(t) is an optimal set-point concentration of S_{NO} at time t, y(t)=[y₁(t), y₂(t)]^{T}, y₁(t) is the concentration of S_{O} at time t, y₂(t) is the concentration of S_{NO} at time t;
(3)-2 outputs of PID controller are variation of manipulated variables oxygen transfer coefficient (ΔK_{L}a) and internal circulation return flow (ΔQₐ);
(4) take ΔK_{L}a and ΔQₐ as an input of a control system of WWTP, and then control S_{O} and S_{NO} by the calculated ΔK_{L}a and ΔQₐ, and outputs of the control system in WWTP are real concentrations of S_{O} and S_{NO}.
